(19) United States
(12) Patent Application Publication
(10) Pub. No.: US 2005/0114432 A1
(43) Pub. Date: May 26, 2005

(54) Methods for providing communications services

(76) Inventors: Donna K. Hodges, Cumming, GA (US); Barrett Morris Kreiner, Norcross, GA (US); Steven N. Tischer, Atlanta, GA (US)

Correspondence Address: Scott P. Zimmerman, P.O. Box 3822, Cary, NC, 27519, US

(21) Appl. No.: 10/720,941

(22) Filed: Nov. 24, 2003

(51) Int. Cl. G06F 15/16

(52) U.S. Cl. 709/201

(57) ABSTRACT

Methods, systems, and products are disclosed for providing communications services. One method receives a first data stream at a computer, and the first data stream includes packets of data packetized according to a packet protocol. The first data stream is segmented into segments, and the segments are dispersed via a network for subsequent processing services. Results of the subsequent processing services are received and aggregated into a second data stream. The second data stream is then communicated via the network to another destination, such as a client communications device.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### CROSS-REFERENCE TO RELATED APPLICATIONS

This application relates to the copending and the commonly assigned U.S. patent application Ser. No. ______, entitled “Methods for Providing Communications Services” (Attorney Docket BS030347), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030348), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030349), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030350), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030351), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030352), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030353), filed concurrently herewith, and of which the “Brief Summary of the Invention” section and the “Detailed Description of the Invention” section are incorporated herein by reference.

This application relates to the copending and the commonly assigned U.S. patent application Ser. No. ______, entitled “Methods for Providing Communications Services” (Attorney Docket BS030356), filed concurrently herewith, and of which the “Brief Summary of the Invention” section and the “Detailed Description of the Invention” section are incorporated herein by reference.

### BACKGROUND OF THE INVENTION

1. Field of the Invention

This invention generally relates to computers and to communications and, more particularly, to processing data in a communications network.

2. Description of the Related Art

Manipulation of electronic data is important in computer networking and in communications. Often times electronic data must be manipulated for presentation at a client communications device. That is, the electronic data must be changed, formatted, or altered to suit the display characteristics, processing abilities, and/or storage capabilities of the client communications device. A handheld personal data assistant, for example, often requires that bandwidth-intensive electronic data, such as on-demand video, be scaled, color corrected, and/or otherwise manipulated for optimum presentation on the small display of the handheld personal data assistant. Heretofore, however, manipulation of electronic data was usually the responsibility of the client communications device—that is, the client communications device stores and utilizes one or more computer programs to manipulate incoming electronic data for presentation on the client communications device.

Locally manipulating electronic data, however, poses problems. As the electronic data is received, the client communications device must store the electronic data, process/manipulate the electronic data, and present the manipulated electronic data to the user. This process of storing, manipulating, and/or presenting the electronic data, however, often taxes the limited processing and storage capabilities of the client communications device. As both those skilled and unskilled recognize, when the processing and/or storage capabilities of the client communications device are overwhelmed, the audio/video presentation may “stumble” and degrade the user experience. Sometimes the client communications device even experiences a fault or failure when the processing and/or storage capabilities are overwhelmed. There is, accordingly, a need in the art for methods and systems of manipulating electronic data that reduce the need for locally-stored computer programs and that reduce the need for local processing requirements.

### BRIEF SUMMARY OF THE INVENTION

The aforementioned problems, and other problems, are reduced by a Analysis Module. This Analysis Module comprises methods, computer systems, computer programs, and computer program products that provide communications services to subscribers. The Analysis Module utilizes a segmentation profile to process a stream of electronic data and then segments the data according to various schemes. The individual segments are routed to other devices and to other software transformation modules, within and without the communications network, for subsequent processing. When the subsequent processing is complete, the Analysis Module aggregates the results and then communicates the aggregated results along the communications network. When the client communications device receives the aggregated results, the client communications device may then view/execute/present the aggregated results with little or no regard for the original format of the data stream. That is, the aggregated results have already been substantially formatted, transformed, processed, and/or manipulated to suit the processing, storage, and/or audio/display requirements of the client communications device.

The data may be segmented according to various objectives, rules, and/or requirements. The Analysis Module, for example, might decide that one segment of data might need color correction to account for the limited/different color capabilities of the client communications device. The Analysis Module might decide another segment must be scaled to suit the size of the display device at the client communications device. Other segments might need transformation from one video standard to another video standard. These various segmentation schemes may be specified by network parameters, by performance criteria, by a profile, and/or by security/privacy requirements. The data may also be segmented and routed according to a template or according to dynamic situations within the network. The data may also be segmented and routed throughout a network to meet a best “Quality of Presentation” goal and/or a contracted Service Level Agreement. Once the Analysis Module decides how the stream of data should be segmented, the individual segments are then dispersed throughout the communications network for processing. When the subsequent processing is complete, the Analysis Module aggregates the results and then communicates the aggregated results along the communications network to the client communications device. The client communications device may then view/execute/present the aggregated results with little or no regard for the original format of the data stream.

This invention discloses methods, systems, and products for providing communications services. One of the embodiments describes a method for providing communications services. A first data stream is received at a computer via a communications network, and the first data stream includes packets of data packetized according to a packet protocol. The first data stream is segmented into segments, and the segments are dispersed via the communications network for subsequent processing services. Results of the subsequent processing services are received via the communications network and aggregated into a second data stream. The second data stream is then communicated via the communications network to another destination, such as a client communications device.

Another of the embodiments describes another method for providing communications services. Here data is received at a computer, and the data is received as packets of data packetized according to a packet protocol. The packets of data are segmented into segments according to a segmentation profile stored in memory. At least one of the segments is dispersed via a network for a subsequent processing service. Results of the subsequent processing service are received, aggregated, and communicated to a client communications device, wherein the aggregated results are formatted according to the segmentation profile.

Other embodiments of this invention describe a system for providing communications services. A Analysis Module is stored in a memory device. The Analysis Module receives data at a computer, and the data is received as packets of data packetized according to a packet protocol. The Analysis Module executes a set of rules to segment the packets of data into segments according to a segmentation profile stored in memory. The Analysis Module disperses at least one of the segments via a network for a subsequent processing service, and the Analysis Module receives and aggregates the results of the subsequent processing service. The Analysis Module communicates the aggregated results to a client communications device, wherein the aggregated results are formatted according to the segmentation profile. The system also includes a processor communicating with the memory device.

Other embodiments of this invention describe a computer program product. A computer-readable medium stores a Analysis Module. The Analysis Module receives data at a computer, and the data is received as packets of data packetized according to a packet protocol. The Analysis Module segments the packets of data into segments according to a segmentation profile stored in memory. The Analysis Module disperses at least one of the segments via a network for a subsequent processing service. The Analysis Module receives and aggregates results of the subsequent processing service. The Analysis Module communicates the aggregated results to a client communications device, wherein the aggregated results are formatted according to the segmentation profile.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIGS. 1 and 2 are simplified schematics illustrating one or more embodiments of this invention;

FIGS. 3-5 depict possible operating environments for one or more embodiments of this invention;

FIGS. 6-11 are schematics illustrating one or more embodiments of this invention for segmenting data;

FIG. 12 is a flowchart illustrating a method of providing communications services according to the embodiments of this invention;

FIGS. 13-16 are flowcharts illustrating a method of segmenting data according to the embodiments of this invention;

FIGS. 17-20 are schematics illustrating another of the embodiments of this invention; and

FIGS. 21 and 22 are schematics illustrating the use of metadata according to even more embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

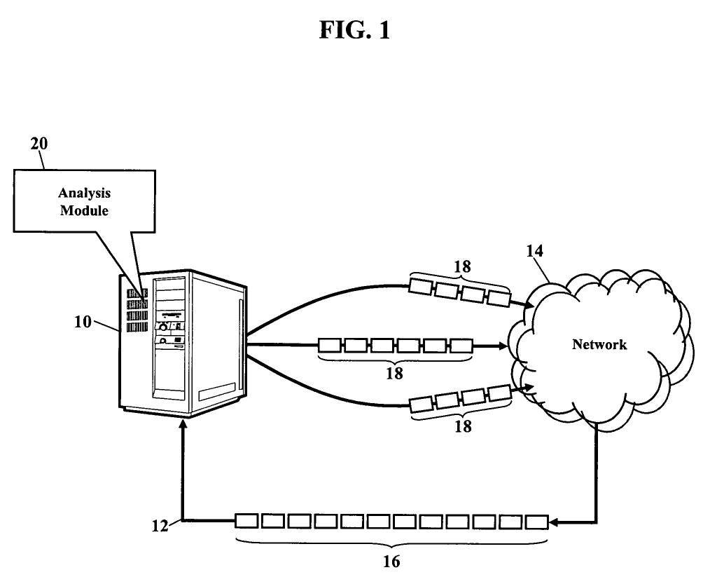

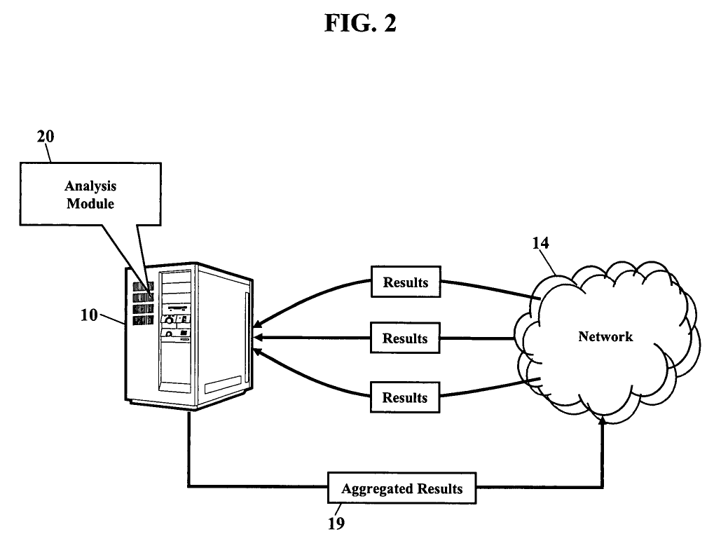

FIGS. 1 and 2 are simplified schematics illustrating this invention. The embodiments of this invention include a Analysis Module 20. The Analysis Module 20 comprises methods, systems, computer programs, and/or computer program products that help provide communications services. The Analysis Module 20 operates within a computer 10. The computer 10 receives a first stream 12 of data via a network 14. The first stream 12 of data typically includes individual packets 16 of information. The first stream 12 of data may have an XML (eXtensible Mark-up Language) format or a non-XML format. As FIG. 1 shows, the Analysis Module 20 acts upon the first stream 12 of data by segmenting the individual packets 16 into segments 18. The individual packets 16 are segmented according to a similar characteristic and/or according to similar processing services, as the following paragraphs will explain in greater detail. Some examples of these similar characteristics and/or similar processing services could include scaling requirements, color requirements, and network routing requirements. Some individual packets, for example, might require a scaling correction factor to achieve a “quality of presentation” objective at a smaller/larger display size. Those packets 16 that require this scaling correction factor are grouped into a segment. Some individual packets might require color correction to achieve that “quality of presentation” objective at a smaller/larger display size. These individual packets requiring color correction are, similarly, grouped into a segment. Other individual packets, requiring a common or similar processing service are segmented. The Analysis Module 20 then disperses the segments 18 via the network 14 for the subsequent processing services. The Analysis Module 20 routes the segments 18 to other devices and/or locations via the network 14, and the subsequent processing services are performed. The Analysis Module 20, for example, routes the segments 18 to a computer, and this computer receives the segments 18 and processes the segments 18.

As FIG. 2 shows, the Analysis Module 20 receives the results of the subsequent processing services. Whatever the results may be (e.g., color corrected segments and scaled segments), the Analysis Module 20 aggregates the results of the processing services into a second data stream 19. The second data stream 19, comprising the aggregated results, is then communicated via the network 14. The client communications device may then view/execute/present the aggregated results with little or no regard for the original format of the stream of data.

Any packet protocol is suitable for this invention. As those of ordinary skill in the art understand, sometimes computer information is packetized (or “framed”) for use in packet networks. The computer information is grouped into packets according to a packet protocol. As those of ordinary skill in the art also understand, there are many packet protocols. Some of the more well-known packet protocols include TCP/IP, IPX/SPX, AppleTalk, and SNA. Some standards organizations, such as the I.E.E.E., issue standards for packetizing data. Because many networks are “mixed”—that is, the network receives and handles packets of differing protocols, a “translator” determines the particular packet protocol and the appropriate destination for each packet. Because the basics of packetizing and packet protocols are well-known, this patent will not further explain the packetizing of the stream 12 of data.

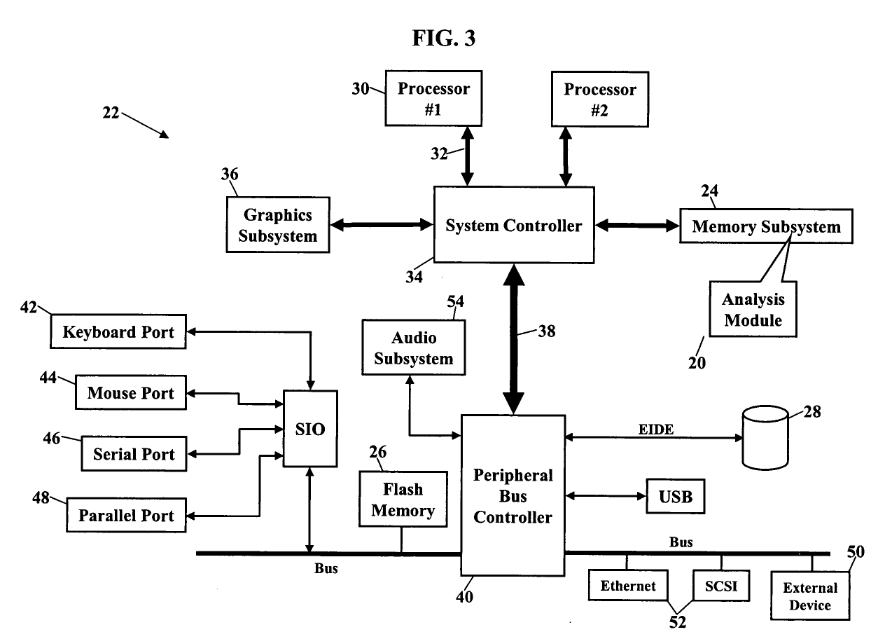

FIGS. 3-5 depict possible operating environments for the embodiments of this invention. The embodiments of this invention include a Analysis Module 20. The Analysis Module 20 comprises methods, systems, computer programs, and/or computer program products that segment data in a communications network. The data is segmented and routed according to various intelligent rules. These various intelligent rules may be specified by a network parameter, by a performance criterion, by a profile, and/or by a security/privacy requirement. The data may also be segmented and routed according to a template or according to a dynamically-defined situation within the communications network. The data may also be segmented and routed throughout the communications network to meet a best “Quality of Presentation” goal and/or a contracted Service Level Agreement (SLA). When the subsequent processing is complete, the Analysis Module 20 aggregates the results and then communicates the aggregated results along the communications network to the client communications device. The client communications device may then view/execute/present the aggregated results with little or no regard for the original format of the data stream. As those of ordinary skill in the art of computer programming recognize, computer processes/programs are depicted as process and symbolic representations of computer operations. Computer components, such as a central processor, memory devices, and/or display devices, execute these and other computer operations. The computer operations include manipulation of data bits by the central processor, and the memory devices maintain the data bits in data structures. The process and symbolic representations are understood, by those skilled in the art of computer programming, to convey the discoveries in the art.

FIG. 3 is a block diagram showing the Analysis Module 20 residing in a computer system 22. The Analysis Module 20 operates within a system memory device. The Analysis Module 20, for example, is shown residing in a memory subsystem 24. The Analysis Module 20, however, could also reside in flash memory 26 or peripheral storage device 28. The computer system 22 also has one or more central processors 30 executing an operating system. The operating system, as is well known, has a set of instructions that control the internal functions of the computer system 22. A system bus 32 communicates signals, such as data signals, control signals, and address signals, between the central processor 30 and a system controller 34 (typically called a “Northbridge”). The system controller 34 provides a bridging function between the one or more central processors 30, a graphics subsystem 36, the memory subsystem 24, and a PCI (Peripheral Controller Interface) bus 38. The PCI bus 38 is controlled by a Peripheral Bus Controller 40. The Peripheral Bus Controller 40 (typically called a “Southbridge”) is an integrated circuit that serves as an input/output hub for various peripheral ports. These peripheral ports are shown including a keyboard port 42, a mouse port 44, a serial port 46 and/or a parallel port 48 for a video display unit, one or more external device ports 50, and networking ports 52 (such as SCSI or Ethernet). The Peripheral Bus Controller 40 also includes an audio subsystem 54. Those of ordinary skill in the art understand that the program, processes, methods, and systems described in this patent are not limited to any particular computer system or computer hardware.

Those of ordinary skill in the art also understand the central processor 30 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 24, flash memory 26, or peripheral storage device 28) may also contain an application program. The application program cooperates with the operating system and with a video display unit (via the serial port 46 and/or the parallel port 48) to provide a Graphical User Interface (GUI). The Graphical User Interface typically includes a combination of signals communicated along the keyboard port 42 and the mouse port 44. The Graphical User Interface provides a convenient visual and/or audible interface with a user of the computer system 22.

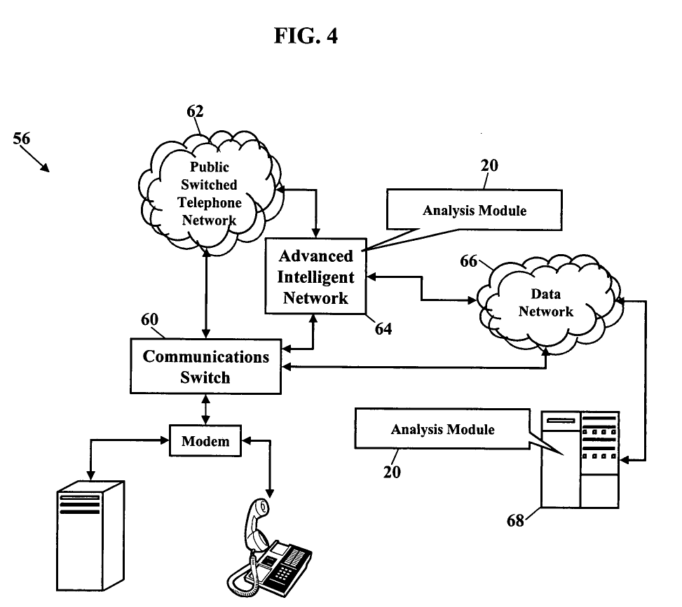

FIG. 4 is a schematic showing the Analysis Module 20 operating within an intelligently-controlled communications network 56. This communications network 56 further represents an operating environment for the Analysis Module 20. The communications network 56 includes a communications switch 60 of a Public Switched Telephone Network 62. The communications switch 60 includes Advanced Intelligent Network (AIN) componentry 64 controlling many features of the communications switch 60. The Advanced Intelligent Network (AIN) componentry 64 includes the Analysis Module 20 operating within the computer system (shown as reference numeral 22 in FIG. 3). The communications switch 60 and the Advanced Intelligent Network (AIN) componentry 64 interfaces with a data network 66. The data network 66 includes a computer server 68 communicating with the data network 66. The Analysis Module 20 also resides within the computer server 68 and receives data via the data network 66. The signaling between the communications switch 60, the Public Switched Telephone Network 62, the Advanced Intelligent Network 64, and the data network 66, however, is well understood in the art and will not be further described. If a reader desires a more detailed explanation, the reader is directed to U.S. Pat. No. 5,430,719 issued to Weisser (Jul. 4, 1995), with the “Summary of the Invention” and the “Detailed Description of the Preferred Embodiment” sections incorporated herein by reference. The reader is also directed to U.S. Pat. No. 5,917,817 issued to Dunn et al. (Jun. 29, 1999), with the “Summary of the Invention” and the “Detailed Description” sections incorporated herein by reference.

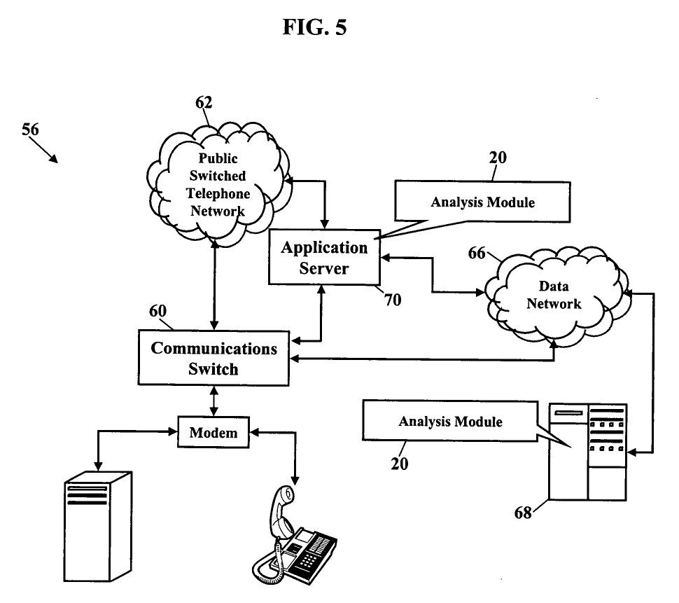

FIG. 5 is similar to FIG. 4, yet FIG. 5 illustrates a packet-network architecture. This packet network represents an alternative operating environment for the Analysis Module 20. Here the communications switch 60 is a packet-based “softswitch.” This softswitch uses software control to provide voice, data, and video services by dynamically changing its connection data rates and protocols types. An application computer server 70 interfaces with the softswitch via a packet protocol, such as Session Initiation Protocol (SIP). This application computer server 70 includes voice service protocols, triggers, and/or operations that allow the Public Switched Telephone Network 62 and the data network 66 to interoperate.

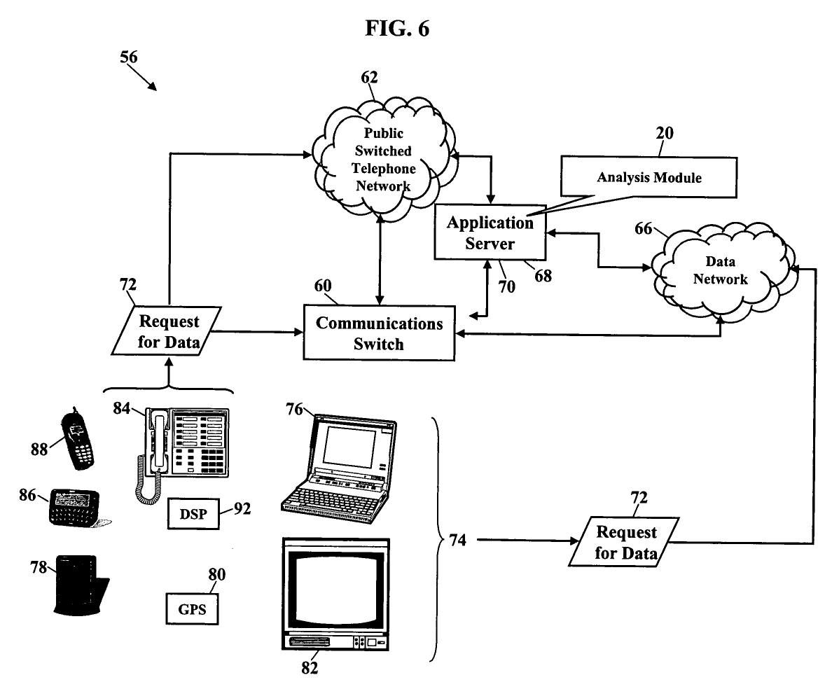

FIGS. 6-11 are schematics illustrating one of the embodiments of this invention for segmenting data. The Analysis Module 20 is a computer program that operates within a client-server environment of the communications network 56. FIG. 6 shows the Analysis Module 20 receiving a request 72 for data. The request 72 for data originates from a client communications device 74. The client communications device 74 is shown as a computer 76 (laptop, desktop, tablet, server, and other computer systems), a personal digital assistant (PDA) 78, a Global Positioning System (GPS) device 80, an interactive television 82, an Internet Protocol (IP) phone 84, a pager 86, a cellular/satellite phone 88, or any computer/communications device utilizing a digital signal processor (DSP) 90. The client communications device 74 may issue the request 72 for data using the communications switch 60, the Public Switched Telephone Network 62, the data network 66, and/or the application server 68 and/or 70. The request 72 for data is communicated via the communications network 56 (e.g., the Public Switched Telephone Network 62, the communications switch 60, and/or the data network 66) to the Analysis Module 20 operating within the application server 68 and/or 70.

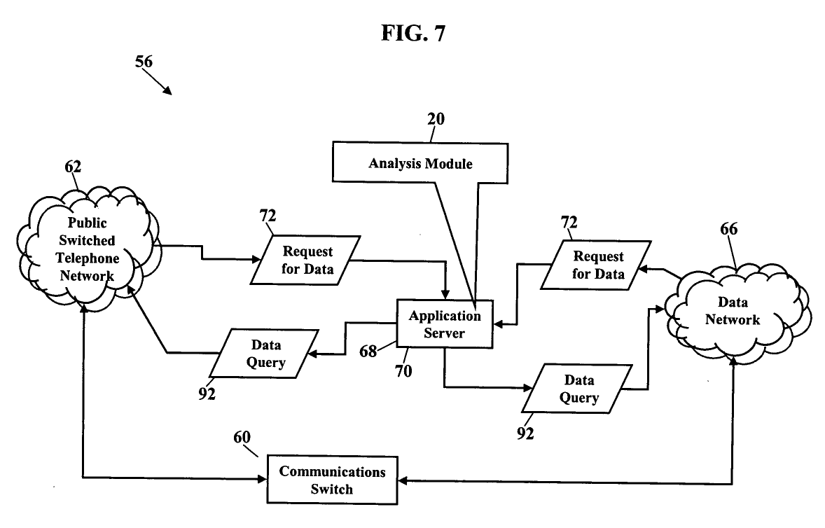

The embodiments of this invention continue with FIG. 7. The application server 68 and/or 70 receives the request 72 for data, analyzes the request 72 for data, and determines what data is requested. The application server 68 and/or 70 then issues a data query 92. The data query 92 is routed along the communications network 56 to the appropriate destination or destinations (not shown for simplicity). The destination(s) may be any device or location that is accessible via the Public Switched Telephone Network 62 or the data network 66. The destination(s), however, is/are typically a remote computer device (not shown for simplicity) communicating with the Public Switched Telephone Network 62 and/or the data network 66. This remote computer device stores the requested data sought by the client communications device (shown as reference numeral 74 in FIG. 6). When this remote computer receives the data query 92, the remote computer retrieves the requested data and return communicates the requested data to the application server 68 and/or 70.

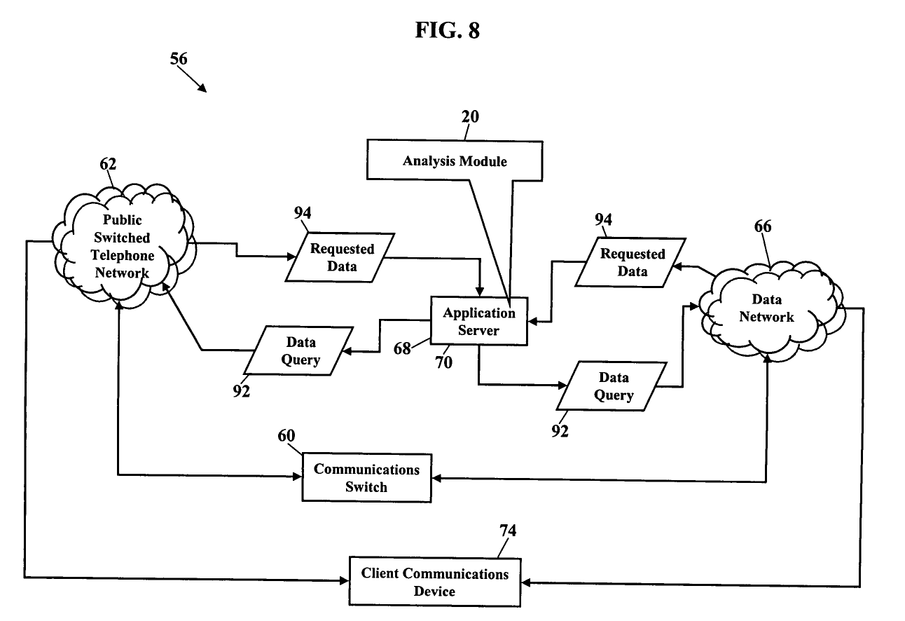

As FIG. 8 shows, the application server 68 and/or 70 then receives the requested data 94. The requested data 94 is typically received as packets of data at the application server 70. The requested data 94, however, could also be received at the communications switch, the Advanced Intelligent Network, and/or the computer server (shown, respectively, as reference numerals 60, 64, and 68 in FIG. 4). A conventional network routing scheme would then forward the requested data 94 to the client communications device 74. Before, however, the requested data 94 is forwarded to the client communications device 74, the Analysis Module 20 of this invention analyzes the requested data 94. The Analysis Module 20 determines whether the requested data 94 requires subsequent processing before forwarding to the client communications device 74. The term “processing” means the requested data 94 is changed, formatted, transformed, configured, compressed, encrypted, addressed, and/or altered to suit another application or another requirement. If the Analysis Module 20 determines that the requested data 94 requires subsequent processing, the Analysis Module 20 segments the requested data 94.

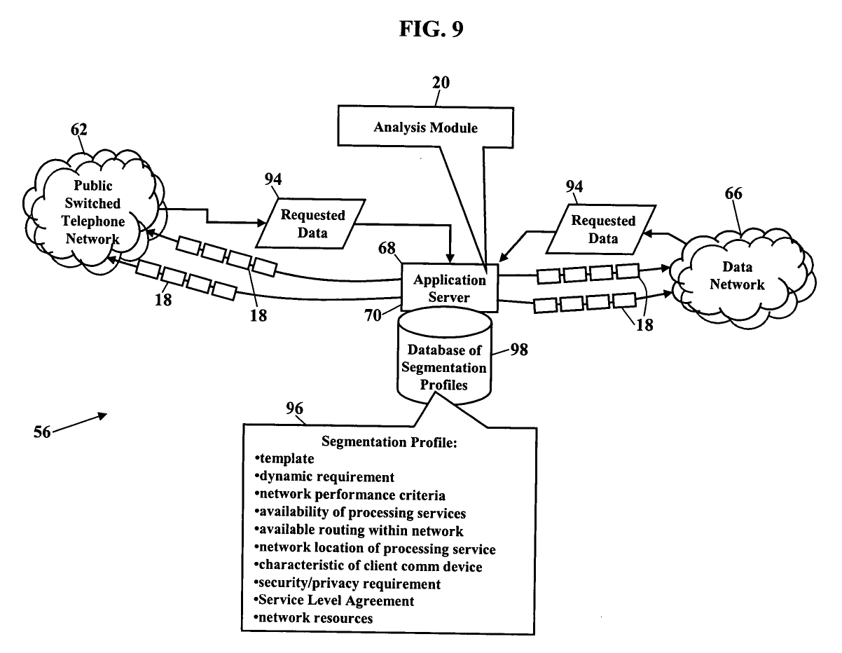

FIG. 9 illustrates segmenting the requested data 94. Before the requested data 94 is forwarded to the client communications device (shown as reference numeral 74 in FIG. 6), this invention analyzes the requested data 94. The Analysis Module 20 determines whether the requested data 94 requires subsequent processing before forwarding to the client communications device. As those of ordinary skill in the art understand, computer information is commonly packetized according to a packet protocol. If one or more subsequent processing services are required, the Analysis Module 20 acts upon the requested data 94 by segmenting the individual packets into the segments 18. The individual packets are segmented according to a similar characteristic or similar processing service(s). The Analysis Module 20 then disperses the segments 18 via the communications network 56 for the subsequent processing services. The Analysis Module 20 routes the segments 18 via the communications network 56 to other destinations or to other computer devices that perform the subsequent processing service(s).

Many factors can determine whether the requested data 94 requires subsequent processing. The requested data 94, for example, may require scaling, color correction, and/or other processing to suit the abilities/characteristics of the client communications device 74. The requested data 94 may need to be converted from one format to another format (e.g., raw video to MPEG or .mp3 to .mp4). The requested data 94 may require too much bandwidth for the client communications device 74, so the requested data 94 may need to be compressed or bandwidth-reduced. The communications network 56, the communications network operator, the client communications device 74, the requested data 94, and/or the customer/client/subscriber may have special security/privacy needs that require subsequent processing of the requested data 94. The communications network 56 itself may experience moments of packet congestion, so network performance and routing considerations may require that the requested data 94 be processed or alternatively routed. If the Analysis Module 20 determines that the requested data 94 requires subsequent processing, the Analysis Module 20 segments the requested data 94 into the segments 18.

Because there may be many factors that determine whether subsequent processing is required, FIG. 9 shows a segmentation profile 96. The Analysis Module 20 may consult the segmentation profile 96 to determine whether to segment the requested data 94. The segmentation profile 96 stores various factors, rules, requirements, characteristics, and/or objectives that help determine whether the requested data 94 should be segmented for subsequent processing. The segmentation profile 96 is stored/maintained in a database 98 of segmentation profiles. The database 98 of segmentation profiles may be stored/maintained at any location, and/or on any device, within the communications network 56. The segmentation profile 96 could also be stored on the client communications device (shown as reference numeral 74 in FIG. 6). FIG. 9, however, shows the database 98 of segmentation profiles operating within, or locally to, the application server 68 and/or 70. The database 98 of segmentation profiles is stored within the system memory device (shown as memory subsystem 24, flash memory 26, or peripheral storage device 28 of FIG. 3).

Before the requested data 94 is forwarded to the client communications device 74, the Analysis Module 20 consults the segmentation profile 96. The segmentation profile 96 specifies what types of data should be subsequently processed. The segmentation profile 96 may also specify how that data should be segmented. If the Analysis Module 20 determines that the requested data 94 requires subsequent processing, the Analysis Module 20 applies the rules, or follows the specifications, stored within the segmentation profile 96. As FIG. 9 shows, the segmentation profile 96 stores various factors, rules, requirements, characteristics, and/or objectives that determine what types of data should be subsequently processed, how that data should be subsequently processed, and/or how that data should be segmented and dispersed. The segmentation profile 96, for example, may specify that certain repetitive structures of the data, or packets of data, should be segmented according to a template. This template may describe the repetitive structure of the data, such as a computer-generated work/service order, data sheet, and/or invoice. The template may describe how the repetitive structure of the data is segmented into the segments 18, and where each segment 18 is routed for subsequent processing. The template may even describe the format of the results of the subsequent processing so that the Analysis Module 20 may verify some aspect of the subsequent processing. If, for example, the requested data 94 has the structure of a template-matching service order for the communications industry, the template could specify how the service order is first segmented and fed to craft, how the service order is segmented another way and sent to billing, and how the service order is segmented yet another way and sent to a switch or other networked device. Each packet of data within each segment 18 shares a common processing characteristic (e.g., craft, billing, switching).

The segmentation profile 96 may contain factors, rules, requirements, characteristics, and/or objectives for dynamic segmenting. The Analysis Module 20 may consult the segmentation profile 96 to segment the requested data 94 according to a dynamic requirement. The dynamic requirement would specify the segmentation of data for when the Analysis Module 20 encounters shifting/changing scenarios. If, for example, the client communications device is a limited bandwidth PDA (shown, respectively, as reference numerals 74 and 78 in FIG. 6), having a 320×240×16 bits per pixel display device, then the Analysis Module 20 segments a video stream into five (5) second segments 18. When the Analysis Module 20 disperses the segments 18 for subsequent processing, the Analysis Module 20 also instructs the subsequent processes to scale and to bandwidth reduce each segment 18 to achieve a best “Quality of Presentation” on the PDA—that is, an optimal or best possible presentation to the client communications device.

The segmentation profile 96 stores other factors, rules, requirements, characteristics, and/or objectives for segmenting. The segmentation profile 96, for example, could contain network performance requirements. The network performance requirements could include rules and/or objectives to efficiently and/or to quickly process data. The Analysis Module 20 may consult the segmentation profile 96 to segment the requested data 94 according to a network performance requirement.

The segmentation profile 96 could store factors, rules, requirements, characteristics, and/or objectives for network availability. The Analysis Module 20 may consult the segmentation profile 96 to segment/disperse the requested data 94 according to the availability of routing within the communications network. Portions of the communications network 56, at any one moment, may experience packet congestion. A communications network device in one location may be congested, while that same communications network device in another, different location may have excess capacity. Routing paths through metropolitan areas may be at capacity, while routing paths in more rural areas have excess capacity. The Analysis Module 20 could consult the segmentation profile 96 for up-to-date routing and network availability information. The Analysis Module 20 would then segment and disperse the requested data 94 according to the availability of routing within the communications network.

The segmentation profile 96 could store factors, rules, requirements, characteristics, and/or objectives describing the availability of the subsequent processing services. The segmentation profile 96 could also store factors, rules, requirements, characteristics, and/or objectives describing the network locations of the subsequent processing services. The Analysis Module 20 could then consult the segmentation profile 96 and segment/disperse the requested data 94 according to the availability/location of the subsequent processing services. A particular transformation software module may be experiencing high demand, while another transformation software module may be underutilized. A transformation software module at a first physical location may be overwhelmed, while that same transformation software module at another location may be idle. The Analysis Module 20 could consult the segmentation profile 96 for real-time, or near real-time, information as to the availability of the subsequent processing services. The Analysis Module 20 would then segment and disperse the requested data 94 according to the availability of the subsequent processing services.

The segmentation profile 96 could store characteristics of the client communications device (shown as reference numeral 74 in FIG. 6). The Analysis Module 20 may consult the segmentation profile 96 to segment and to disperse the requested data 94 according to these characteristics of the client communications device. When the client communications device sends the request for data (shown as reference numeral 72 in FIG. 6), this request for data could include this characteristic of the client communications device. The characteristic of the client communications device could also be mapped or cross-referenced to a static/dynamic Internet Protocol (IP) address. The characteristic of the client communications device could describe or identify the memory capabilities and/or the processing capabilities of the client communications device. The characteristic of the client communications device could describe or identify the central processor and the size and/or the color capabilities of the display device. The characteristic of the client communications device could describe or identify the modality capabilities (such as voice, text, graphics, and/or holographic). Because the Analysis Module 20 may know one or more characteristics of the client communications device, the Analysis Module 20 may segment and disperse the requested data 94 to achieve a best “Quality of Presentation” on the client communications device.

The segmentation profile 96 may also store security/privacy requirements. These security and privacy requirements could contain rules, characteristics, and/or objectives for maintaining the security and/or the privacy of the requested data 94. The Analysis Module 20 could consult the segmentation profile 96 to segment the requested data 94 according to these security and privacy requirements. Some customers, for example, may require that the requested data 94 be randomly segmented and then routed to the client communications device (shown as reference numeral 74 in FIG. 6). Because the requested data 94 is sensitive, no subsequent processing is desired. Even if one of the random segments is intercepted, the random segment may not be considered a security/privacy breach. Other customers, however, may want each random segment specially processed for added security/privacy concerns. The Analysis Module 20 could consult the segmentation profile 96 to obtain these security/privacy requirements. The Analysis Module 20 would then segment and disperse the requested data 94 according to the security/privacy requirements.

The segmentation profile 96 may also store requirements for a Service Level Agreement. As those of ordinary skill in the art recognize, a Service Level Agreement defines service commitments between a communications service provider and the customer/subscriber. The Service Level Agreement, for example, may require that the customer/subscriber have access to a specified upstream/downstream bit rate (or “bandwidth”). The Service Level Agreement might require that ninety nine percent (99%) of the requested data 94 be processed and delivered within three hundred (300) seconds. The Service Level Agreement, however, may also define “microscopic” service requirements—that is, the Service Level Agreement defines service requirements on a per-transaction basis. With each data transmission, the customer/subscriber may specify, for that data transmission, the required level of service. Various telecommunication service providers could bid for that data transmission, subject to the required microscopic level of service. What ever the Service Level Agreement specifies, the requirements of the Service Level Agreement could be stored in the segmentation profile 96. The Analysis Module 20, then, would consult the segmentation profile 96 and to segment/disperse the requested data 94 according to the Service Level Agreement.

The segmentation profile 96 may also store customer/subscriber-accessible resources. The customer/subscriber-accessible resources would describe communications network resources of which the subscriber may access. The customer/subscriber, for example, may have permission to utilize network-based storage devices. The customer/subscriber may also have permission to utilize network-based processing host servers. If the customer/subscriber has permission to utilize network-based resources, the Analysis Module 20 could segment the requested data 94 to accommodate, or to take advantage of, these resources.

As FIG. 9 shows, after the Analysis Module 20 consults the segmentation profile 96, the segments 18 are dispersed. The application server 68 and/or 70 receives the requested data 94 via the Public Switched Telephone Network 62 and/or the data network 66. The Analysis Module 20 acts upon the requested data 94 by segmenting individual packets into the segments 18. The individual packets are segmented according to a similar characteristic and/or a similar processing service. The Analysis Module 20 then disperses the segments 18 for the subsequent processing services via the Public Switched Telephone Network 62 and/or the data network 66.

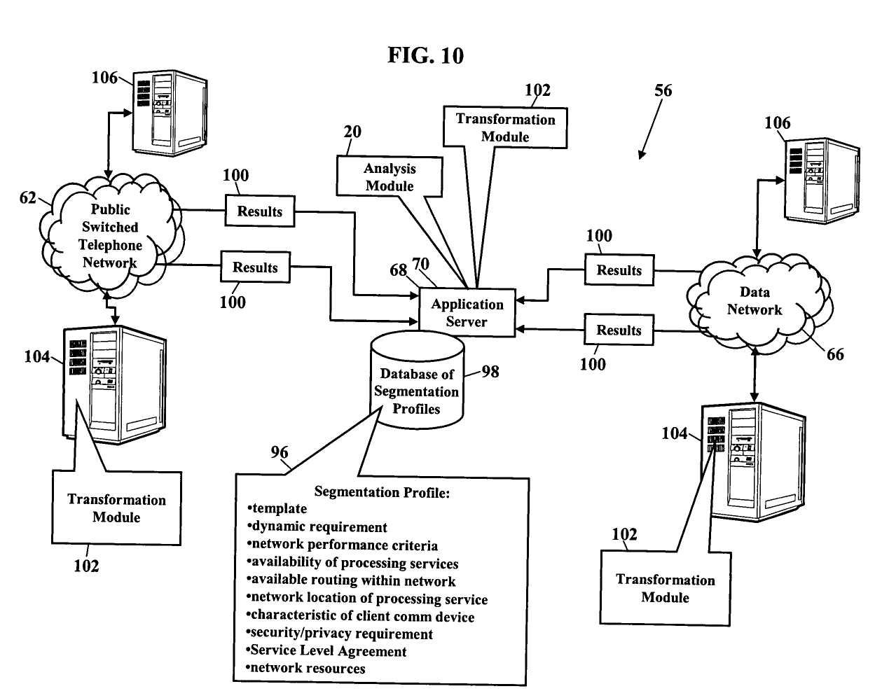

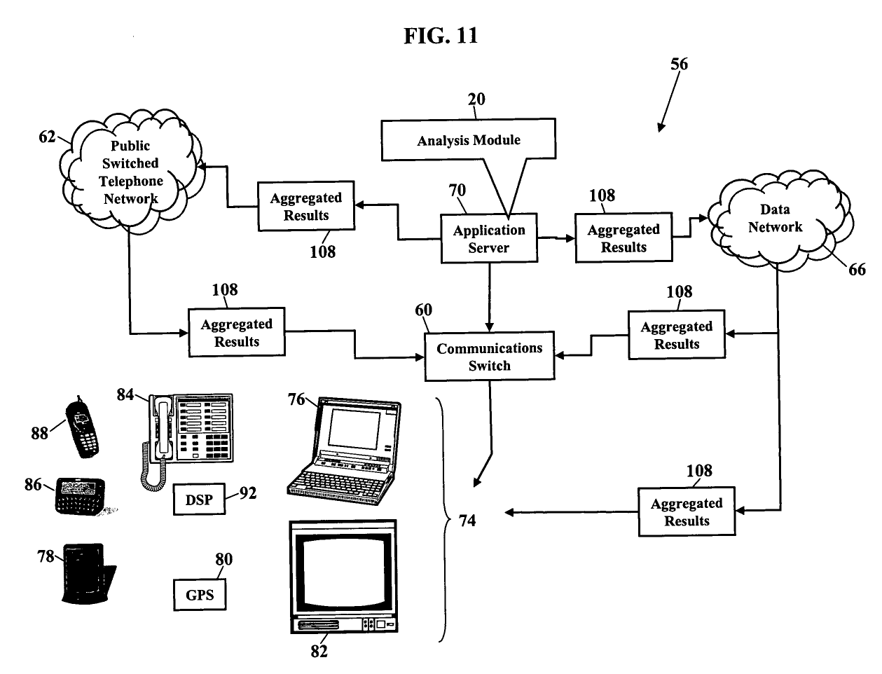

FIGS. 10 and 11 are schematics further illustrating another of the embodiments of this invention. FIG. 10 shows the Analysis Module 20 receiving the results 100 of the subsequent processing services. The subsequent processing services may be performed by a transformation module 102. The transformation module 100 is stored in the memory device (such as reference numerals 24, 26, and 28 of FIG. 3) of a network device 104. The network device 104 may a computer operating within, or communicating with, the communications network 56. The transformation module 100 could also be stored in the memory device of the application server 68 and/or 70 and interface with the Analysis Module 20. The subsequent processing services may also be performed by an outside, third-party vendor's device 106. Whatever the subsequent processing service(s), and whether intra- or inter-networked, the Analysis Module 20 aggregates the results 100 of the processing services. FIG. 11, then, shows the Analysis Module 20 communicating aggregated results 108 along the communications network 56. The aggregated results 108 could be communicated via the communications switch 60, via the Public Switched Telephone Network 62, and/or via the data network 66. The application server 68 and/or 70, communicating with the communications switch 60, could aggregate the results 100 of the processing services for a near real-time delivery to the client communications device 74.

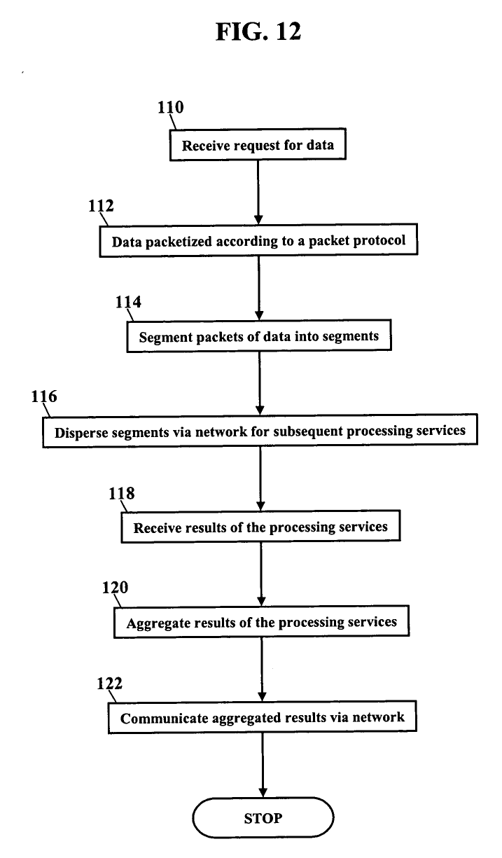

FIG. 12 is a flowchart illustrating a method of providing communications services. A request for data is received (Block 110). The requested data is received at a computer, and the data is received as packets of data packetized according to a packet protocol (Block 112). The packets of data are segmented into segments (Block 114), and the segments are dispersed for subsequent processing services (Block 116). Results of the processing services are received (Block 118) and aggregated (Block 120). The aggregated results are then communicated via the network (Block 122).

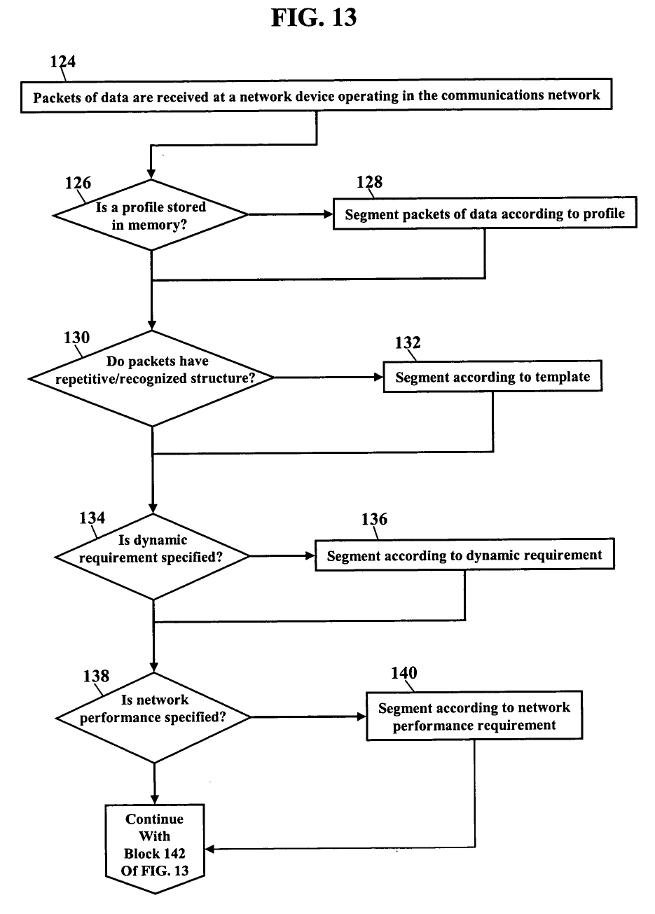

FIGS. 13-16 are flowcharts illustrating one or more methods for providing communications services according to the embodiments of this invention. Packets of data are received at a network device operating in the communications network (Block 124). The packets of data are packetized according to a packet protocol. If a profile is stored in memory (Block 126), then the packets of data are segmented according to the profile (Block 128). If the packets of data have a repetitive or recognized structure (Block 130), the packets of data may be segmented according to a template (Block 132). If a dynamic requirement is specified (Block 134), the packets of data may be segmented according to the dynamic requirement (Block 136). If a network performance requirement is specified (Block 138), the packets of data may be segmented according to the network performance requirement (Block 140).

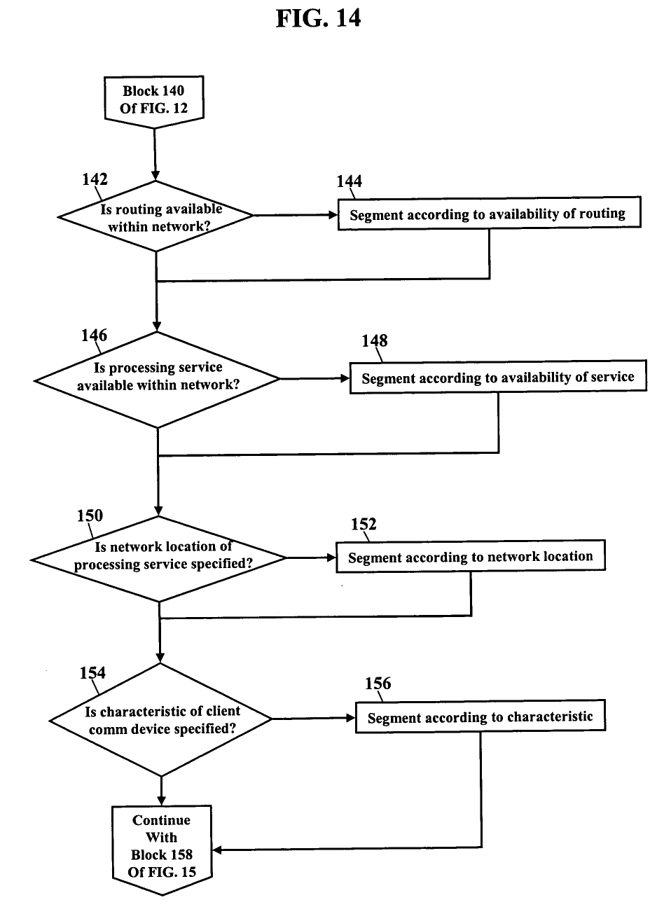

The flowchart continues with FIG. 14. If routing within the communications network is available (Block 142), the packets of data may be segmented according to availability of routing (Block 144). If processing services within the communications network are available (Block 146), the packets of data may be segmented according to availability of the subsequent processing services (Block 148). If a network location of the subsequent processing services is specified (Block 150), the packets of data may be segmented according to the network location (Block 152). If a characteristic of a client communications device is specified (Block 154), the packets of data may be segmented according to this characteristic (Block 156).

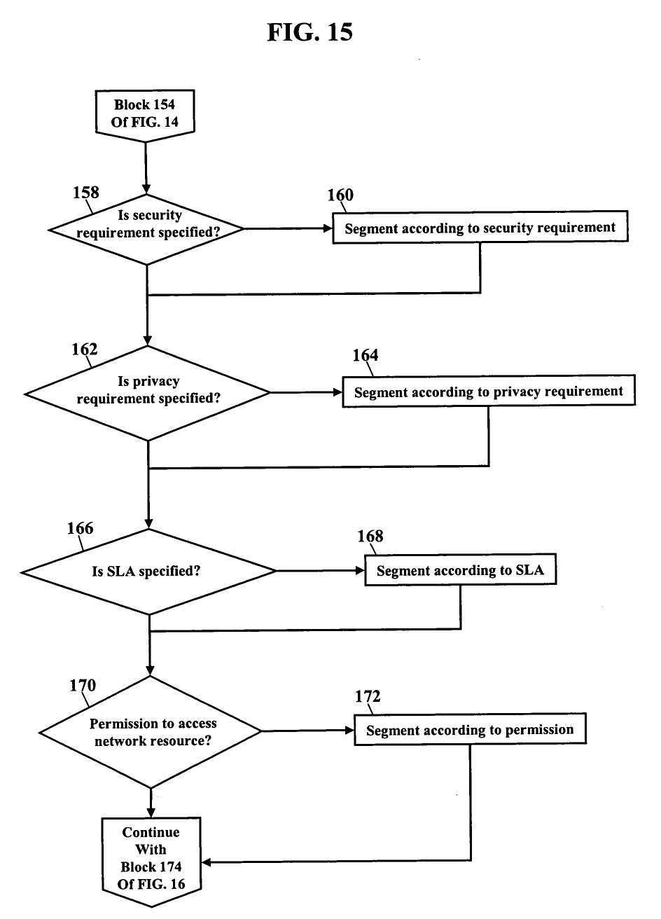

The flowchart continues with FIG. 15. If a security requirement is specified (Block 158), the packets of data may be segmented according to this security requirement (Block 160). If a privacy requirement is specified (Block 162), the packets of data may be segmented according to this privacy requirement (Block 164). If a Service Level Agreement (SLA) is specified (Block 166), the packets of data may be segmented according to the Service Level Agreement (Block 168). If the subscriber has permission to access a network resources (Block 170), the packets of data may be segmented according to the permission (Block 172).

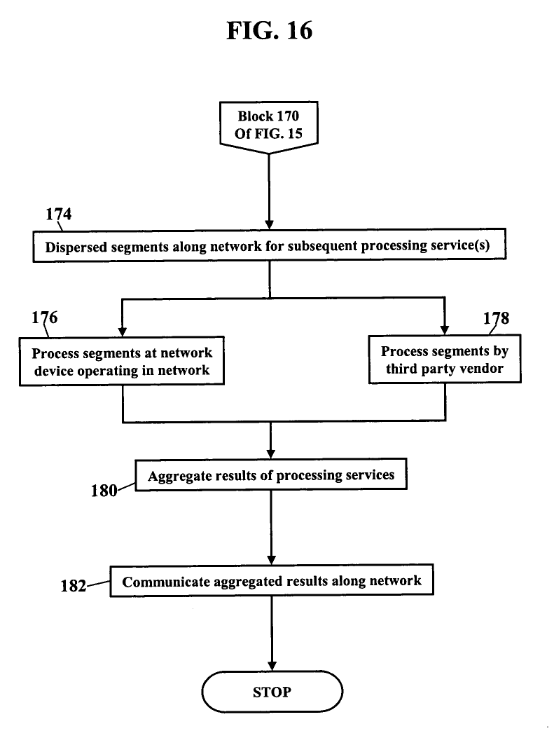

The flowchart continues with FIG. 16. Once the packets of data are segmented, the segments are dispersed along the communications network for subsequent processing services (Block 174). The segments may be processed at a network device operating in the communications network (Block 176). The segments may be processed by a third party vendor (Block 178). The results of the processing services are aggregated (Block 180) and communicated (Block 182) along the communications network.

The Analysis Module 20 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Analysis Module 20 to be easily disseminated. A computer program product for segmenting data includes the Analysis Module 20 stored on the computer-readable medium. The Analysis Module 20 receives packets of data, segments the packets of data into segments, and disperses the segments along a communications network for subsequent processing services. The Analysis Module 20 then receives and aggregates the results of the processing services. The Analysis Module 20 also communicates the results along the communications network.

The Analysis Module 20 may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

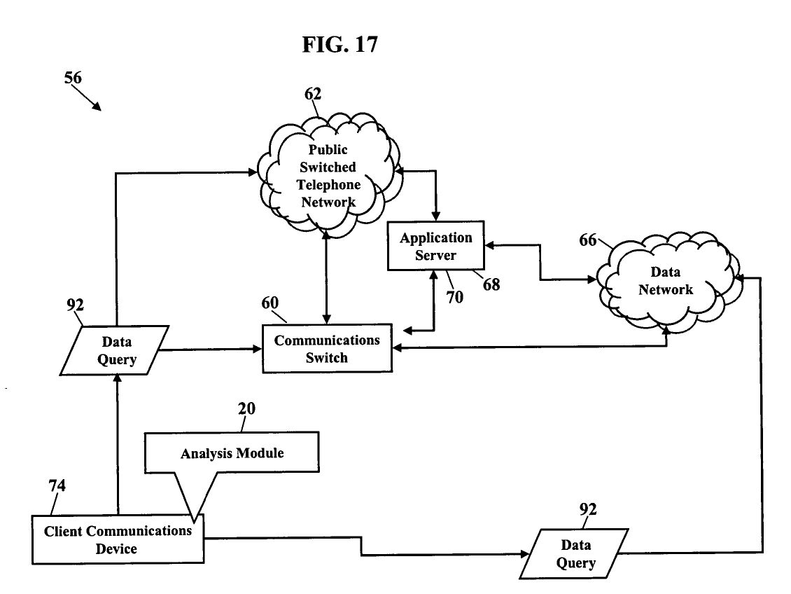

FIGS. 17-20 are schematics illustrating another of the embodiments of this invention. This embodiment is similar to that shown FIGS. 6-11, although here the Analysis Module 20 resides in the client communications device 74. When the client communications device 74 requires data from the communications network 56, FIG. 17 shows the client communications device 74 issuing the data query 92. The data query 92 routes along the communications network 56 to the appropriate destination or destinations (not shown for simplicity). The destination(s) may be any device or location that is accessible via the Public Switched Telephone Network 62 or the data network 66. The destination(s), however, is/are typically a remote computer device (not shown for simplicity) communicating with the Public Switched Telephone Network 62 and/or the data network 66. This remote computer device stores the requested data sought by the client communications device (shown as reference numeral 74 in FIG. 6). When this remote computer receives the data query 92, the remote computer retrieves the requested data and return communicates the requested data to the application server 68 and/or 70.

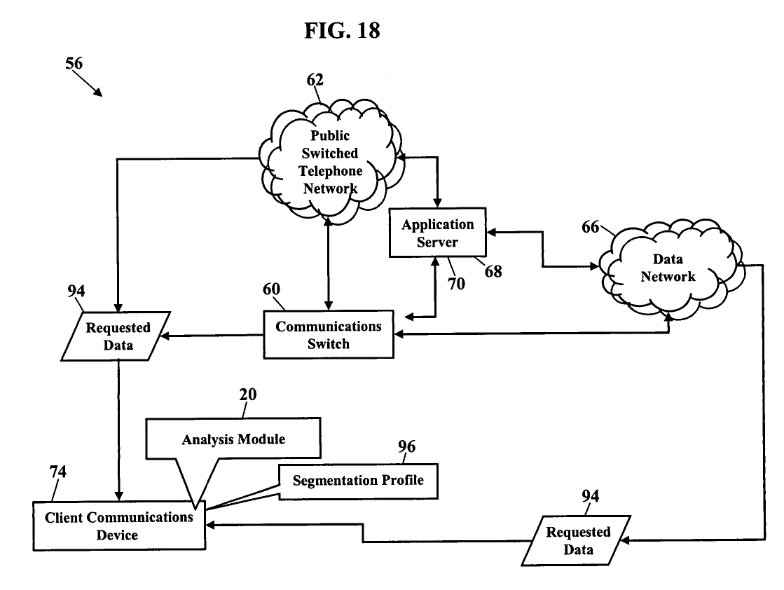

As FIG. 18 shows, the Analysis Module 20 then receives the requested data 94. The requested data 94 is received as packets of data at the client communications device 74. The Analysis Module 20 of this invention analyzes the requested data 94 to determine whether the requested data 94 requires subsequent processing before presentation on the client communications device 74. The Analysis Module 20 may consult the segmentation profile 96 to determine whether to segment the requested data 94. The segmentation profile 96 stores various factors, rules, requirements, characteristics, and/or objectives that help determine whether the requested data 94 should be segmented for subsequent processing. The segmentation profile 96 is shown stored within memory of the client communications device 74. If the Analysis Module 20 determines that the requested data 94 requires subsequent processing, the Analysis Module 20 segments the requested data 94.

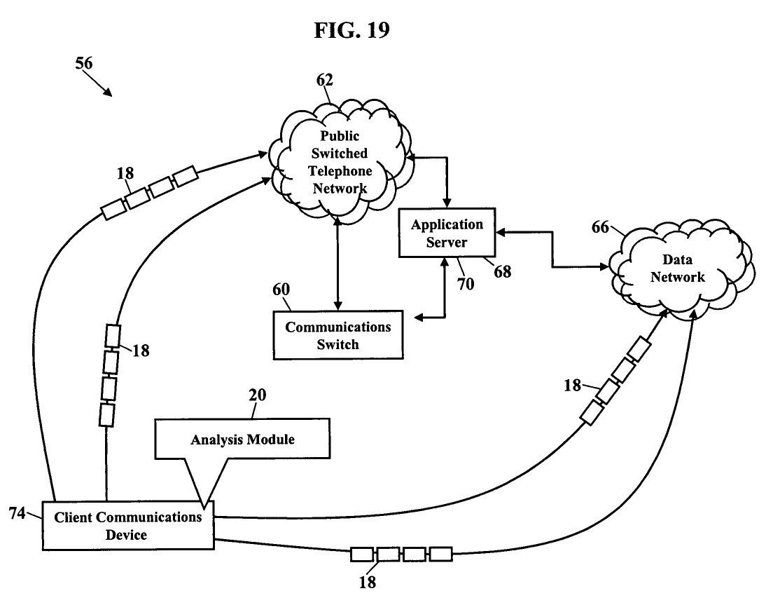

FIG. 19 illustrates segmentation of the requested data (shown as reference numeral 94 in FIG. 18). Before the requested data is presented on the client communications device 74, the Analysis Module 20 determines whether the requested data 94 requires subsequent processing. If one or more subsequent processing services are required, the Analysis Module 20 acts upon the requested data by segmenting the individual packets into the segments 18. The individual packets are segmented according to a similar characteristic or similar processing service(s). The Analysis Module 20 then disperses the segments 18 via the communications network 56 for the subsequent processing services. The Analysis Module 20 routes the segments 18 via the communications network 56 to other destinations or to other computer devices that perform the subsequent processing service(s).

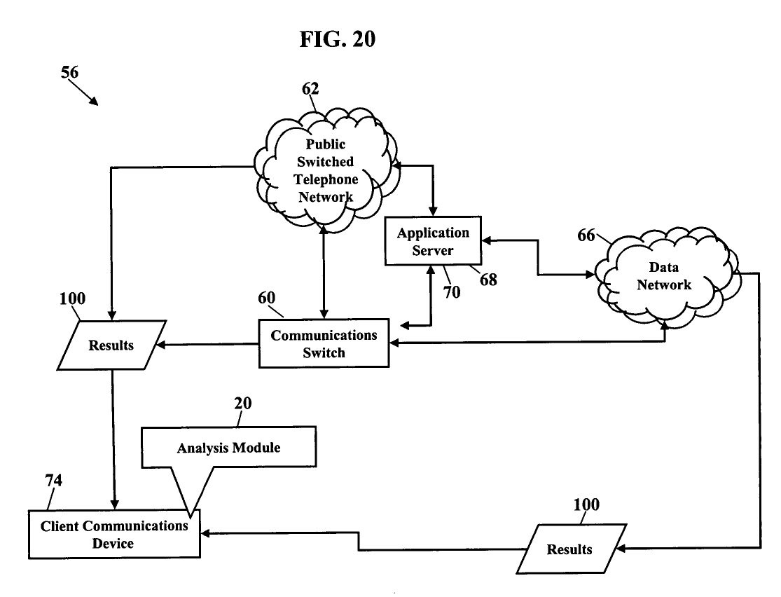

FIG. 20 shows the Analysis Module 20 receiving the results 100 of the subsequent processing services. Whatever the subsequent processing service(s), and whether intra- or inter-networked, the Analysis Module 20 aggregates the results 100 of the processing services. The aggregated results are now formatted according to the factors, rules, requirements, characteristics, and/or objectives contained within the segmentation profile (shown as reference numeral 96 in FIG. 18). The aggregated results 108 are then presented on the client communications device 74.

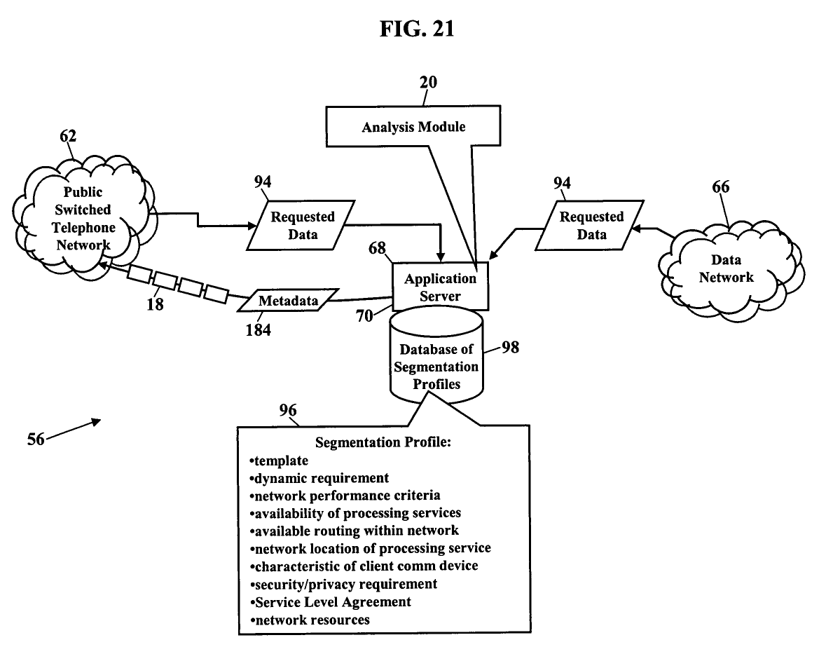

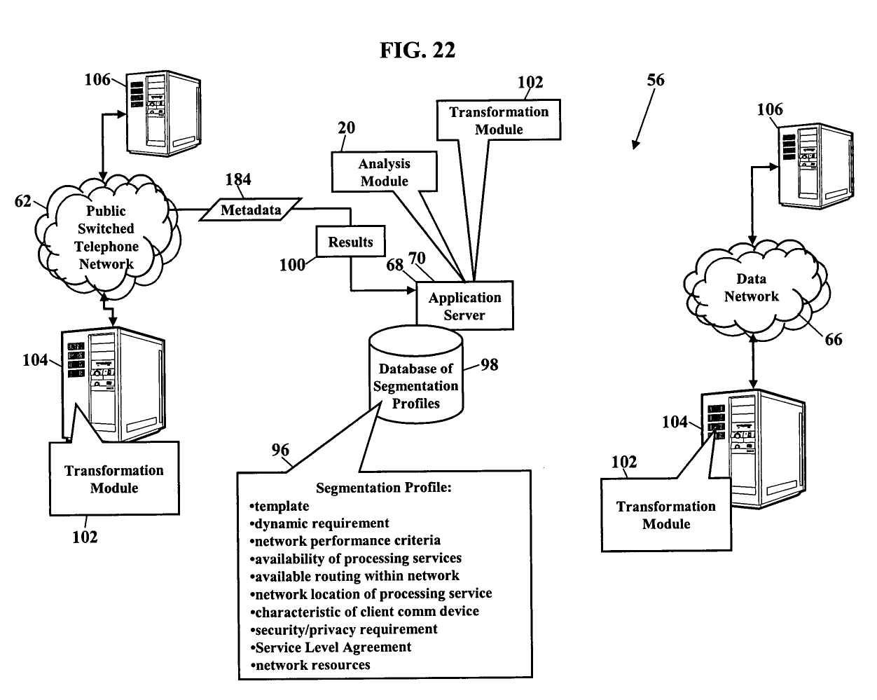

FIGS. 21 and 22 are schematics illustrating yet another of the embodiments of this invention. FIG. 21 illustrates the use of metadata 184 to “tag” one or more of the segments 18, while FIG. 22 illustrates the metadata 184 describing the results 100 of the subsequent processing. The term “metadata” describes any data, description, narration, or explanation of other data. As FIG. 21 shows, the Analysis Module 20 may add, append, supplement, or tag the segment 18 with the metadata 184. The metadata 184 may be any information, such as a description of a rule or requirement that caused the requested data 94 to be segmented. The metadata 184 could even include audio/textual narration that further describes the segmentation factors, rules, requirements, characteristics, and/or objectives. The metadata 184 could even describe that subsequent processing. FIG. 22 shows the Analysis Module 20 receiving the results 100 of the subsequent processing services. The results 100 of the subsequent processing services, likewise, include the metadata 184.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method of providing communications services, comprising the steps of:
receiving a first data stream at a computer, the first data stream comprising packets of data packetized according to a packet protocol;
segmenting the first data stream into segments;
dispersing the segments via a network for subsequent processing services;
receiving results of the processing services;
aggregating the results of the processing services into a second data stream; and
communicating the second data stream via the network.

2. A method according to claim 1, further comprising the step of receiving a request for the first data stream, the request originating from a client communications device.

3. A method of providing communications services, comprising the steps of:
receiving data at a computer, the data received as packets of data packetized according to a packet protocol;
segmenting the packets of data into segments according to a segmentation profile stored in memory;
dispersing at least one of the segments via a network for a subsequent processing service;
receiving results of the subsequent processing service;
aggregating the results of the subsequent processing service; and
communicating the aggregated results to a client communications device, wherein the aggregated results are formatted according to the segmentation profile.

4. A method according to claim 3, further comprising the step of processing at least one of the segments at a network device operating in the communications network.

5. A method according to claim 3, wherein the step of dispersing the segments comprises dispersing according to the segmentation profile.

6. A method according to claim 3, wherein the step of segmenting the packets of data comprises segmenting according to a template, the template describing a repetitive structure of the packets of data.

7. A method according to claim 3, wherein the step of segmenting the packets of data comprises segmenting according to a dynamic requirement.

8. A method according to claim 3, wherein the step of segmenting the packets of data comprises segmenting according to a network performance requirement.

9. A method according to claim 3, wherein the step of segmenting the packets of data comprises segmenting according to availability of routing within the communications network.

10. A method according to claim 3, wherein the step of segmenting the packets of data comprises segmenting according to availability of the subsequent processing service.

11. A method according to claim 3, wherein the step of segmenting the packets of data comprises segmenting according to a network location of the subsequent processing service.

12. A method according to claim 3, wherein the step of segmenting the packets of data comprises segmenting according to a characteristic of the client communications device.

13. A method according to claim 3, wherein the step of segmenting the packets of data comprises segmenting according to a security requirement.

14. A method according to claim 3, wherein the step of segmenting the packets of data comprises segmenting according to a privacy requirement.

15. A method according to claim 3, wherein the step of segmenting the packets of data comprises segmenting according to a Service Level Agreement.

16. A method according to claim 3, wherein the step of segmenting the packets of data comprises segmenting according to a subscriber's schedule.

17. A method according to claim 3, wherein the step of segmenting the packets of data comprises segmenting according to a subscriber's presence.

18. A method according to claim 3, wherein the step of segmenting the packets of data comprises segmenting according to communications network resources of which a subscriber may access.

19. A system, comprising:
a Analysis Module stored in a memory device, the Analysis Module receiving data at a computer, the data received as packets of data packetized according to a packet protocol, the Analysis Module segmenting the packets of data into segments according to a segmentation profile stored in memory, the Analysis Module dispersing at least one of the segments via a network for a subsequent processing service, the Analysis Module receiving and aggregating results of the subsequent processing service, the Analysis Module communicating the aggregated results to a client communications device, wherein the aggregated results are formatted according to the segmentation profile; and
a processor communicating with the memory device.

20. A computer program product, comprising:
a computer-readable medium; and
a Analysis Module stored on the computer-readable medium, the Analysis Module receiving data at a computer, the data received as packets of data packetized according to a packet protocol, the Analysis Module segmenting the packets of data into segments according to a segmentation profile stored in memory, the Analysis Module dispersing at least one of the segments via a network for a subsequent processing service, the Analysis Module receiving and aggregating results of the subsequent processing service, the Analysis Module communicating the aggregated results to a client communications device, wherein the aggregated results are formatted according to the segmentation profile.
